(19) United States
(12) Patent Application Publication
(10) Pub. No.: US 2024/0289388 A1
(43) Pub. Date: Aug. 29, 2024

(54) GRAPH STATE DATA MANAGEMENT

(71) Applicant: Alipay (Hangzhou) Information Technology Co., Ltd., Hangzhou (CN)

(72) Inventors: Haodong TANG, Hangzhou (CN); Zhenxuan PAN, Hangzhou (CN)

(21) Appl. No.: 18/572,446

(22) PCT Filed: Nov. 10, 2022
(86) PCT No.: PCT/CN2022/131007

§ 371 Date: Dec. 20, 2023

(30) Foreign Application Priority Data
Nov. 11, 2021 (CN) 202111332991.X

(51) Int. Cl. G06F 16/901; G06F 16/13; G06F 16/906

(52) U.S. Cl. CPC G06F 16/9024; G06F 16/13; G06F 16/906

(57) ABSTRACT

Embodiments of this specification provide a graph state data management method and apparatus. The method includes: encoding, after acquiring batch graph state data from a graph computing engine, each piece of graph state data in the batch graph state data into kv data; sorting the kv data based on a key of the kv data to form kv list data, where in the kv list data, each key corresponds to one or more values; next, sequentially writing values of the kv list data into a data file in a file storage system, and recording a corresponding logical address of each key in the data file; and then, maintaining a memory index of the batch graph state data in a memory of a graph state management device, where the maintained memory index is used to reflect an index relationship between a key and a corresponding logical address.

### TECHNICAL FIELD

Embodiments of this specification generally relate to the graph computing field, and in particular, to a graph state data management method and a graph state data management apparatus.

### BACKGROUND

Graph computing is complex computing performed on a graph data structure. During graph computing, a graph computing engine abstracts real service data into a graph data structure and performs complex computing. The graph data structure is a complex data structure formed by vertices and edges, and the data structure includes a plurality of data attributes.

The graph computing performed by the graph computing engine is iterative computation. During each round of iterative computation, the graph computing engine generates an intermediate result, and the generated intermediate result may be referred to as graph state data. In some real-time graph computing application scenarios, the constructed real-time graph computing engine has a graph computing capability of integrating streaming computation and graph computing. To ensure data fault tolerance in streaming computation, the graph state data needs to be stored in, for example, a memory or a cache of the graph computing engine, or a local disk, and the stored graph state data needs to be managed.

### SUMMARY

In view of the above-mentioned description, embodiments of this specification provide a graph state data management method and apparatus. According to the graph state data management method and apparatus, graph state management can be decoupled from graph computing, so as to implement separation of computation and storage, and implement larger-scale graph state data management.

According to an aspect of embodiments of this specification, a graph state data management method applied to a graph state management device is provided, including: batch acquiring graph state data that is obtained by a graph computing engine during graph computation, where the graph state data includes vertex data and/or edge data; encoding each piece of graph state data in the graph state data into kv data, where a vertex ID in the vertex data and/or a start ID in the edge data is encoded into a key, and non-vertex ID data in the vertex data and/or non-start ID data in the edge data is encoded into a value; sorting the list based on a key of the kv data to form kv list data, where in the kv list data, each key corresponds to one or more values; sequentially writing values of the kv list data into a data file in a file storage system, and recording a corresponding logical address of each key in the data file, where the logical address includes a file ID of a data file into which the value corresponding to the key is written, and a first file offset address of the corresponding value in the written data file; and maintaining a memory index of the graph state data in a memory of the graph state management device, where the memory index is used to reflect an index relationship between a key and a corresponding logical address.

Optionally, in an example of the above-mentioned aspect, the memory of the graph state management device maintains a mutable data table and an immutable data table; before the sorting the kv data based on a key of the kv data, the graph state data management method may further include: writing the kv data into the mutable data table; and determining whether a data size of the mutable data table into which the kv data is written reaches a threshold; correspondingly, the sorting the kv data based on a key of the kv data may include: in response to that the data size of the mutable data table into which the kv data is written reaches the threshold, sorting, based on the key of the kv data, the kv data written into the mutable data table, to form the kv list data; and the sequentially writing values of the kv list data into a data file in a file storage system may include: converting the sorted mutable data table into an immutable data table; and sequentially writing values of the immutable data table into a data file in the file storage system, where each immutable data table corresponds to one data file.

Optionally, in an example of the above-mentioned aspect, the sequentially writing values of the kv list data into a data file in a file storage system may include: constructing the values of the kv list data into a plurality of ordered data blocks with a first data size; performing data compression on the constructed ordered data blocks; and sequentially writing the ordered data blocks obtained after the data compression into a data file in the file storage system, where the data file includes each ordered data block obtained after the data compression and a metadata block, and metadata in the metadata block records a mapping relationship between the first file offset address corresponding to the key and a second file offset address of the compressed ordered data block in the data file.

Optionally, in an example of the above-mentioned aspect, the graph state data management method may further include: in response to receiving a graph state data reading request from the graph computing engine, encoding a data ID in the graph state data reading request into a target key, where the data ID includes a vertex ID and/or an edge start ID; querying a corresponding logical address in the memory index based on the target key; acquiring a value corresponding to the target key based on the logical address; decoding the acquired value to obtain target graph state data; and providing the obtained target graph state data to the graph computing engine.

Optionally, in an example of the above-mentioned aspect, the acquiring a value corresponding to the target key based on the logical address may include: in response to identifying the corresponding logical address, initiating a data acquisition request to the file storage system, where the data acquisition request includes the corresponding logical address; and receiving, from the file storage system, a value returned in response to the graph state data acquisition request, where the returned value is acquired by the file storage system from a data file in the file storage system based on the corresponding logical address.

Optionally, in an example of the above-mentioned aspect, the memory of the graph state management device maintains a data LRU cache, and the data LRU cache is used to cache the previously acquired value in association with the corresponding logical address of the key; and before the initiating a data acquisition request to the file storage system, the acquiring a value corresponding to the target key based on the logical address may further include: determining, based on the logical address, whether the value corresponding to the target key is cached in the data LRU cache; and when the value corresponding to the target key is cached in the data LRU cache, acquiring the corresponding value from the data LRU cache.

Optionally, in an example of the above-mentioned aspect, a value of the graph state data is constructed into a plurality of ordered data blocks with a first data size, the ordered data blocks are written into a data file in the file storage system after data compression, the data file includes each ordered data block obtained after the data compression and a metadata block, and metadata in the metadata block records a mapping relationship between the first file offset address corresponding to the key and a second file offset address of the compressed ordered data block in the data file; and correspondingly, the acquiring a value corresponding to the target key based on the logical address may include: in response to identifying the corresponding logical address, initiating a data block acquisition request to the file storage system, where the data block acquisition request includes the corresponding logical address; receiving, from the file storage system, a compressed data block returned in response to the data block acquisition request, where the compressed data block is acquired by the file storage system from a data file in the file storage system based on the first file offset address; decompressing the obtained compressed data block; determining, based on the first file offset address in the logical address and the first data size, a third offset address of the value corresponding to the target key in the decompressed data block; and acquiring the value corresponding to the target key from the decompressed data block based on the third offset address.

Optionally, in an example of the above-mentioned aspect, the memory of the graph state management device maintains a data block LRU cache, and the data block LRU cache is used to cache the previously acquired data block in association with the corresponding logical address of the key; and before the initiating a data acquisition request to the file storage system, the acquiring a value corresponding to the target key based on the logical address may further include: determining, based on the logical address, whether the compressed data block corresponding to the target key is cached in the data block LRU cache; and when the compressed data block corresponding to the target key is cached in the data block LRU cache, acquiring the corresponding compressed data block from the data block LRU cache.

Optionally, in an example of the above-mentioned aspect, before the providing the obtained graph state data to the graph computing engine, the graph state data management method may further include: performing data filtering on the obtained graph state data by using a given data filtering policy.

Optionally, in an example of the above-mentioned aspect, after the sequentially writing values of the kv list data into a data file in a file storage system, and recording a corresponding logical address of each key in the data file, the graph state data management method may further include: determining whether the memory index needs to be updated; and in response to determining that the memory index needs to be updated, performing incremental logical address update on a corresponding logical address in the memory index by using the recorded logical address of each key.

Optionally, in an example of the above-mentioned aspect, the graph state data management method may further include: in response to satisfying a data aggregation condition, performing data aggregation on the graph state data stored in the data file in the file storage system by using a given data aggregation policy.

According to another aspect of embodiments of this specification, a graph state data management apparatus applied to a graph state management device is provided, including: a graph state data acquisition unit, configured to batch acquire graph state data that is obtained by a graph computing engine during graph computation, where the graph state data includes vertex data and/or edge data; a first data encoding unit, configured to encode each piece of graph state data in the graph state data into kv data, where a vertex ID in the vertex data and/or a start ID in the edge data is encoded into a key, and non-vertex ID data in the vertex data and/or non-start ID data in the edge data is encoded into a value; a data sorting unit, configured to sort the kv data based on a key of the kv data to form kv list data, where in the kv list data, each key corresponds to one or more values; a first data writing unit, configured to sequentially write values of the kv list data into a data file in a file storage system; a logical address recording unit, configured to record a corresponding logical address of each key in the data file, where the logical address includes a file ID of a data file into which the value corresponding to the key is written, and a first file offset address of the corresponding value in the written data file; and a memory index maintenance unit, configured to maintain a memory index of the graph state data in a memory of the graph state management device, where the memory index is used to reflect an index relationship between a key and a corresponding logical address.

Optionally, in an example of the above-mentioned aspect, the memory of the graph state management device maintains a mutable data table and an immutable data table; the graph state data management apparatus may further include: a second data writing unit, configured to: before the sorting the kv data based on a key of the kv data, write the kv data into the mutable data table; and a first judging unit, configured to determine whether a data size of the mutable data table into which the kv data is written reaches a threshold, where the data sorting unit is configured to: in response to that the data size of the mutable data table into which the kv data is written reaches the threshold, sort, based on the key of the kv data, the kv data written into the mutable data table, to form the kv list data; and the graph state data management apparatus may further include: a data table conversion unit, configured to convert the sorted mutable data table into an immutable data table, where the first data writing unit is configured to sequentially write values of the immutable data table into a data file in the file storage system, where each immutable data table corresponds to one data file.

Optionally, in an example of the above-mentioned aspect, the first data writing unit may include: a data block constructing module, configured to construct the values of the kv list data into a plurality of ordered data blocks with a first data size; a data block compressing module, configured to perform data compression on the constructed ordered data blocks; and a data block writing module, configured to sequentially write the ordered data blocks obtained after the data compression into a data file in the file storage system, where the data file includes each ordered data block obtained after the data compression and a metadata block, and metadata in the metadata block records a mapping relationship between the first file offset address corresponding to the key and a second file offset address of the compressed ordered data block in the data file.

Optionally, in an example of the above-mentioned aspect, the graph state data management apparatus may further include: a second data encoding unit, configured to: in response to receiving a graph state data reading request from the graph computing engine, encode a data ID in the graph state data reading request into a target key, where the data ID includes a vertex ID and/or an edge start ID; a logical address querying unit, configured to query a corresponding logical address in the memory index based on the target key; a data acquisition unit, configured to acquire a value corresponding to the target key based on the logical address; a data decoding unit, configured to decode the acquired value to obtain target graph state data; and a data providing unit, configured to provide the obtained target graph state data to the graph computing engine.

Optionally, in an example of the above-mentioned aspect, the data acquisition unit may include: a data acquisition request initiating module, configured to: in response to identifying the corresponding logical address, initiate a data acquisition request to the file storage system, where the data acquisition request includes the corresponding logical address; and a data acquisition module, configured to receive, from the file storage system, a value returned in response to the data acquisition request, where the returned value is acquired by the file storage system from a data file in the file storage system based on the corresponding logical address.

Optionally, in an example of the above-mentioned aspect, the memory of the graph state management device maintains a data LRU cache, and the data LRU cache is used to cache the previously acquired value in association with the corresponding logical address of the key; and the data acquisition unit may further include: a data cache judging module, configured to: before the initiating a data acquisition request to the file storage system, determine, based on the logical address, whether the value corresponding to the target key is cached in the data LRU cache, where when the value corresponding to the target key is cached in the data LRU cache, the data acquisition module acquires the corresponding value from the data LRU cache.

Optionally, in an example of the above-mentioned aspect, a value of the graph state data is constructed into a plurality of ordered data blocks with a first data size, the ordered data blocks are written into a data file in the file storage system after data compression, the data file includes each ordered data block obtained after the data compression and a metadata block, and metadata in the metadata block records a mapping relationship between the first file offset address corresponding to the key and a second file offset address of the compressed ordered data block in the data file; and correspondingly, the data acquisition unit may include: a data block acquisition request initiating module, configured to: in response to identifying the corresponding logical address, initiate a data block acquisition request to the file storage system, where the data block acquisition request includes the corresponding logical address; a data block acquisition module, configured to receive, from the file storage system, a compressed data block returned in response to the data block acquisition request, where the compressed data block is acquired by the file storage system from a data file in the file storage system based on the first file offset address; a data block decompressing module, configured to decompress the obtained compressed data block; an offset address determining module, configured to determine, based on the first file offset address in the logical address and the first data size, a third offset address of the value corresponding to the target key in the decompressed data block; and a data acquisition module, configured to acquire the value corresponding to the target key from the decompressed data block based on the third offset address.

Optionally, in an example of the above-mentioned aspect, the memory of the graph state management device maintains a data block LRU cache, and the data block LRU cache is used to cache the previously acquired data block in association with the corresponding logical address of the key; and the data acquisition unit may further include: a data block cache judging module, configured to: before the initiating a data block acquisition request to the file storage system, determine, based on the logical address, whether the compressed data block corresponding to the target key is cached in the data block LRU cache, where when the compressed data block corresponding to the target key is cached in the data block LRU cache, the data block acquisition module acquires the corresponding compressed data block from the data block LRU cache.

Optionally, in an example of the above-mentioned aspect, the graph state data management apparatus may further include: a data filtering unit, configured to: before the providing the obtained graph state data to the graph computing engine, perform data filtering on the obtained graph state data by using a given data filtering policy.

Optionally, in an example of the above-mentioned aspect, the graph state data management apparatus may further include: a memory index update judging unit, configured to: after the sequentially writing values of the kv list data into a data file in a file storage system, and recording a corresponding logical address of each key in the data file, determine whether the memory index needs to be updated; and a memory index updating unit, configured to: in response to determining that the memory index needs to be updated, perform incremental logical address update on a corresponding logical address in the memory index by using the recorded logical address of each key.

Optionally, in an example of the above-mentioned aspect, the graph state data management apparatus may further include: a data aggregation unit, configured to: in response to satisfying a data aggregation condition, perform data aggregation on the graph state data stored in the data file in the file storage system by using a given data aggregation policy.

According to another aspect of embodiments of this specification, a graph state data management apparatus is provided, including: at least one processor; a memory coupled to the at least one processor; and a computer program stored in the memory, where the at least one processor executes the computer program to implement the above-mentioned graph state data management method.

According to another aspect of embodiments of this specification, a computer-readable storage medium is provided, where the computer-readable storage medium stores an executable instruction, and when being executed, the instruction enables a processor to perform the above-mentioned graph state data management method.

According to another aspect of embodiments of this specification, a computer program product is provided, including a computer program, where the computer program is executed by a processor to implement the above-mentioned graph state data management method.

### BRIEF DESCRIPTION OF DRAWINGS

The essence and advantages of this specification can be further understood with reference to the following accompanying drawings. In the accompanying drawings, similar components or features may have the same reference numerals.

FIG. 1 is an example schematic diagram of a graph state management architecture according to an embodiment of this specification;

FIG. 2 is an example flowchart of a graph state data writing method according to an embodiment of this specification;

FIG. 3 is an example schematic diagram of kv list data according to an embodiment of this specification;

FIG. 4 is an example schematic diagram of a memory index structure according to an embodiment of this specification;

FIG. 5 is an example schematic diagram of a data file writing process according to an embodiment of this specification;

FIG. 6 is an example schematic diagram of a data file into which graph state data is written according to an embodiment of this specification;

FIG. 7 is another example flowchart of a graph state data writing method according to an embodiment of this specification;

FIG. 8 is an example flowchart of a memory index update process according to an embodiment of this specification;

FIG. 9 is an example schematic diagram of an updated memory index structure according to an embodiment of this specification;

FIG. 10 is an example flowchart of a graph state data aggregation (compact) process according to an embodiment of this specification;

FIG. 11 is an example flowchart of a graph state data reading method according to an embodiment of this specification;

FIG. 12 is an example flowchart of a value acquisition process according to an embodiment of this specification;

FIG. 13 is another example flowchart of a value acquisition process according to an embodiment of this specification;

FIG. 14 is an example block diagram of a graph state data management apparatus according to an embodiment of this specification;

FIG. 15 is an example block diagram of a first data writing unit according to an embodiment of this specification;

FIG. 16 is another example block diagram of a graph state data writing component according to an embodiment of this specification;

FIG. 17 is an example block diagram of a data acquisition unit according to an embodiment of this specification;

FIG. 18 is another example block diagram of a data acquisition unit according to an embodiment of this specification; and

FIG. 19 is an example schematic diagram of a graph state data management apparatus implemented based on a computer system according to an embodiment of this specification.

### DESCRIPTION OF EMBODIMENTS

The subject matters described in this specification are discussed below with reference to example implementations. It should be understood that the discussion of these implementations is merely intended to enable a person skilled in the art to better understand the subject matters described in this specification, and is not intended to limit the protection scope, applicability, or examples described in the claims. The functions and arrangements of the elements under discussion can be changed without departing from the protection scope of this specification. Various processes or components can be omitted, replaced, or added in various examples as needed. For example, the described method can be performed in a sequence different from the described sequence, and the steps can be added, omitted, or combined. In addition, the features described in some examples can also be combined in other examples.

As used in this specification, the term “include” and variants thereof represent an open term, which means “including but not limited to”. The term “based on” represents “at least partially based on”. The terms “one embodiment” and “an embodiment” represent “at least one embodiment”. The term “another embodiment” represents “at least one other embodiment”. The terms “first”, “second”, and the like may refer to different or identical objects. Other definitions, whether explicit or implicit, may be included below. Unless expressly specified in the context, the definition of a term is consistent throughout this specification.

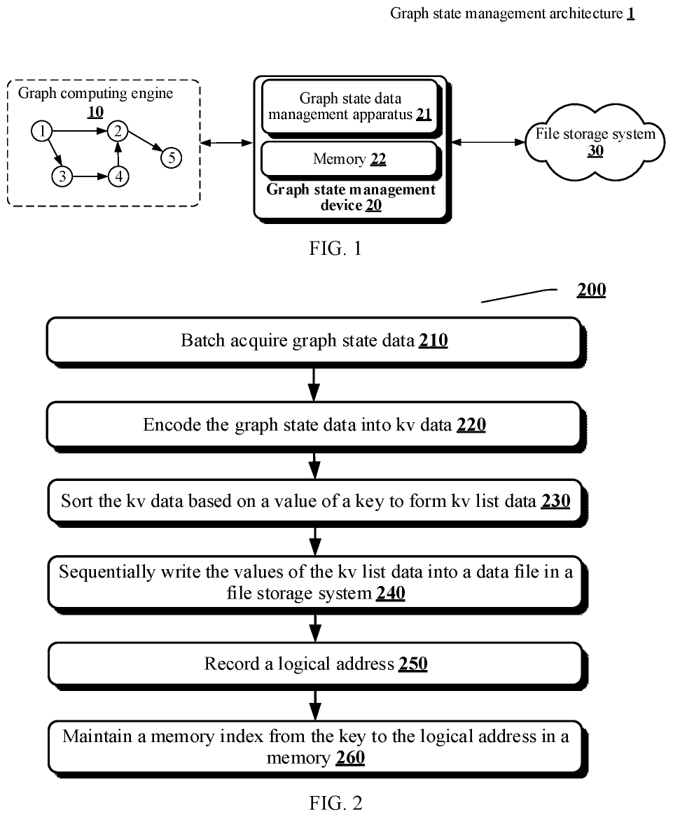

FIG. 1 is an example schematic diagram of a graph state management architecture 1 according to an embodiment of this specification. As shown in FIG. 1, the graph state management architecture 1 includes a graph computing engine 10, a graph state management device 20, and a file storage system 30.

The graph computing engine 10 is configured to perform graph computing by using graph data. During graph computing, the graph computing engine 10 abstracts real service data into a graph data structure. The graph data may include vertex data and edge data. The vertex data may include, for example, a vertex identifier and a vertex attribute. In an example, the vertex identifier may include a vertex ID and a vertex type. In another example, the vertex identifier may include only a vertex ID. The vertex identifier is used to uniquely identify a vertex in the graph data. The edge data may include an edge identifier and an edge attribute. The edge identifier may include a start ID, an edge type, an edge timestamp, and an end ID. Alternatively, the edge identifier may include a start ID and an end ID. The vertex identifier, the edge identifier, the vertex attribute, and the edge attribute may be related to a service. For example, in a social network scenario, the vertex ID may be a person's identity card number, a person number, etc. The vertex type may be a category to which a vertex belongs, for example, a vertex is classified as a user-type vertex. The vertex attribute may include an age, an education, an address, an occupation, etc. The edge type is used to indicate a type to which an edge belongs. For example, if a transfer edge is created between a vertex A and a vertex B, the edge type of the transfer edge may be “transfer”. The edge attribute may include an attribute of an edge formed between vertices. For example, in the above-mentioned transfer edge, the edge attribute may include “amount”, “currency”, “operating device”, etc.

The graph computing performed by the graph computing engine 10 is iterative computation. During each round of iterative computation, the graph computing engine 10 generates an intermediate result, and the generated intermediate result may be referred to as graph state data. The graph computing engine 10 may include any graph computing engine applicable to the art. In some real-time graph computing application scenarios, the graph computing engine 10 may have a graph computing capability of integrating streaming computation and graph computing.

The graph state data generated by the graph computing engine 10 is provided to the graph state management device 20. The graph state management device 20 includes a graph state data management apparatus 21 and a memory 22. The graph state data management apparatus 21 is configured to manage graph state data, for example, write (store) the graph state data into the file storage system 30, and perform data update, data read, data filtering, expired data deletion, and/or data aggregation on the graph state data written into the file storage system 30. In some embodiments, the graph computing engine 10 and the graph state management device 20 can be deployed independently. In some embodiments, the graph state management device 20 can be integrated with the graph computing engine 10. In this case, the graph state management device 20 can share the same memory with the graph computing engine 10.

The file storage system 30 may also be referred to as an external storage system, for example, a cloud file storage system. The file storage system 30 can support multiple data backups or other data redundancy mechanisms to ensure data reliability. In some embodiments, the file storage system 30 may be a distributed file storage system.

FIG. 2 is an example flowchart of a graph state data writing method 200 according to an embodiment of this specification.

As shown in FIG. 2, at 210, after the graph computing engine obtains the graph state data through graph computing, the graph state data management apparatus acquires batch graph state data from the graph computing engine. The acquired graph state data may include vertex data and/or edge data. The vertex data may include a vertex ID, vertex metadata, a vertex attribute, etc. The edge data may include a start ID and an end ID of the edge, edge metadata, an edge attribute, etc. In an example, the vertex metadata and the edge metadata may be fixed to 8 bytes, and may include timestamp information, whether it is a point, whether it is an outgoing edge or an incoming edge, a user-defined label, etc. The vertex attribute and/or the edge attribute may be a custom attribute.

At 220, the graph state data management apparatus encodes each piece of graph state data in the acquired graph state data into kv data. When the graph state data is vertex data, the vertex ID in the vertex data is encoded into a key in the kv data, and the non-vertex ID data in the vertex data is encoded into a value in the kv data. The non-vertex ID data may include, for example, vertex metadata and a vertex attribute. When the graph state data is edge data, the start ID in the edge data is encoded into a key in the kv data, and the non-start ID data in the edge data is encoded into a value in the kv data. The non-start ID data may include, for example, an end ID, edge metadata, and an edge attribute.

At 230, the graph state data management apparatus sorts, based on the key of the kv data, the kv data obtained through encoding, to form the kv list data. For example, the kv data can be sorted based on an ID size of the vertex ID or the edge start ID, and the values with the same key can be aggregated to form the kv list data. For example, if two or more pieces of graph state data have the same key, the values corresponding to the two or more pieces of graph state data are aggregated together. In the formed kv list data, each key may correspond to one or more values.

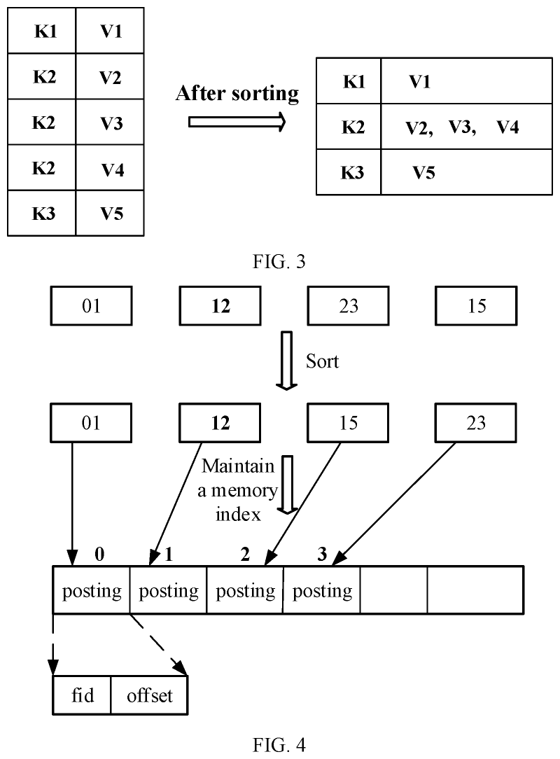

FIG. 3 is an example schematic diagram of kv list data according to an embodiment of this specification. In the example of FIG. 3, five pieces of graph state data are obtained from the graph computing engine, and five pieces of kv data (K1, V1), (K2, V2), (K2, V3), (K2, V4), and (K3, V5) are obtained after the five pieces of graph state data are encoded. After sorting is performed based on the key and value aggregation is performed, kv list data shown on the right is obtained. In the kv list data, K1 corresponds to V1, K2 corresponds to V2, V3, and V4, and K3 corresponds to V5.

As described above, after the kv list data is obtained, at 240, the graph state data management apparatus sequentially writes the values of the kv list data into the data file in the file storage system, and at 250, the graph state data management apparatus records the corresponding logical address of each key in the data file, where the recorded logical address includes a file ID of a data file into which the value corresponding to the key is written, and a first file offset address of the corresponding value in the written data file. Here, sequential writing means writing the values into the data file in sequence based on the sorting of the keys corresponding to the values.

At 260, the graph state data management apparatus maintains a memory index of the written batch graph state data in a memory of the graph state management device, where the memory index is used to reflect an index relationship between a key and a corresponding logical address. In this specification, a plurality of memory index structures, such as an FST, a skip list, and a CSR, can be supported. In the maintained memory index, an index of the memory index corresponds to a key obtained through encoding based on the vertex ID or the edge start ID, that is, the index is obtained based on a sorting result of the key. A value of the memory index corresponds to a logical address of the value corresponding to each key in the data file in the file storage system.

FIG. 4 is an example schematic diagram of a memory index structure according to an embodiment of this specification. In the example of FIG. 4, the memory index is stored in a java array structure. An index in the array structure corresponds to a key obtained through encoding based on the vertex ID or the edge start ID, that is, the index is obtained based on a sorting result of the key. A value in the array structure corresponds to a logical address of the value corresponding to each key in the data file in the file storage system.

As shown in FIG. 4, it is assumed that there are four pieces of graph state data A, B, C, and D. The corresponding keys after data encoding are 01, 12, 23, and 15, respectively. After sorting, the sorting result of the graph state data A, B, C, and D is A, B, D, and C. During maintenance of the memory index, 01, 12, 23, and 15 respectively correspond to index0, index1, index3, and index2 in the memory index result. A storage location corresponding to index0 records a file ID (fid) of a data file into which a value corresponding to 01 is written, and a first file offset address (offset) of the corresponding value in the written data file. A storage location corresponding to index1 records a file ID (fid) of a data file into which a value corresponding to 12 is written, and a first file offset address (offset) of the corresponding value in the written data file. A storage location corresponding to index2 records a file ID (fid) of a data file into which a value corresponding to 15 is written, and a first file offset address (offset) of the corresponding value in the written data file. A storage location corresponding to index3 records a file ID (fid) of a data file into which a value corresponding to 23 is written, and a first file offset address (offset) of the corresponding value in the written data file. The file ID (fid) of the data file and the first file offset address (offset) of the corresponding value in the data file form a posting structure in the memory index structure.

In some embodiments, to further reduce the amount of data written into the file storage system, data compression can be performed on the value of the sorted kv list data, and the compressed value can be written into the file storage system.

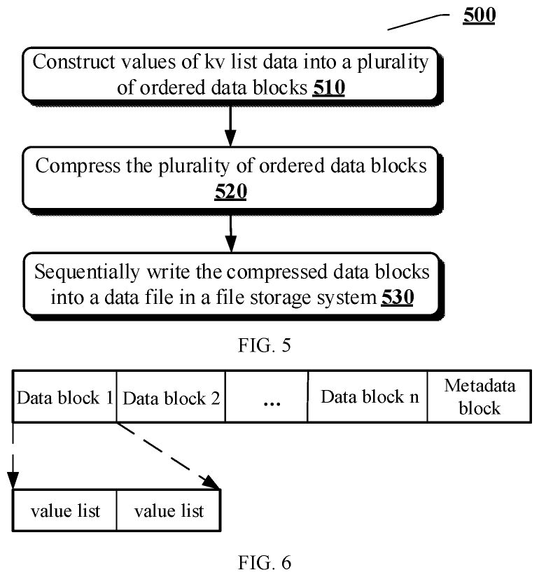

FIG. 5 is an example schematic diagram of a data file writing process 500 according to an embodiment of this specification. In the data file writing process shown in FIG. 5, a value written into the data file is subjected to data compression.

As shown in FIG. 5, when the values of the kv list data are sequentially written into the data file in the file storage system, at 510, the graph state data management apparatus constructs the values of the kv list data into a plurality of ordered data blocks with a first data size. Here, the ordered data blocks are constructed in order based on the sorting of the keys corresponding to the values, and the constructed ordered data blocks are also sorted. A key corresponding to a value in an ordered data block that ranks ahead ranks higher than keys corresponding to all values in other ordered data blocks that rank behind the ordered data block. In addition, the constructed ordered data blocks may have the same data size such as 64 k.

At 520, the graph state data management apparatus performs data compression on the constructed ordered data blocks. For example, the same data compression algorithm can be used to perform data compression on the constructed ordered data blocks, so that the ordered data blocks obtained after the data compression have the same data size.

At 530, the graph state data management apparatus sequentially writes the ordered data blocks obtained after the data compression into a data file in the file storage system, where the data file includes each ordered data block obtained after the data compression and a metadata block. Metadata in the metadata block records a mapping relationship between the first file offset address corresponding to the key and a second file offset address of the compressed ordered data block in the data file.

It should be noted that the mapping relationship recorded in the metadata may be a many-to-one mapping relationship or a one-to-many mapping relationship, that is, a plurality of first file offset addresses correspond to one second file offset address, or one first file offset address corresponds to a plurality of second file offset addresses. For example, in the data writing process shown in FIG. 3, it is assumed that the values corresponding to 01 and 12 are constructed into data block 1 (block 1), and the value corresponding to 15 is constructed into data block 2 (block 2), and the value corresponding to 23 is constructed into data blocks 3 and 4 (block 3 and block 4). In this case, in the metadata, a mapping relationship is formed between the second file offset address of block 1 in the data file and each of the first file offset address offset1 corresponding to 01 and the first file offset address offset2 corresponding to 12, a mapping relationship is formed between the first file offset address offset3 corresponding to 15 and the second file offset address of block 2 in the data file, and a mapping relationship is formed between the first file offset address offset4 corresponding to 23 and the second file offset addresses of block 3 and block 4 in the data file.

FIG. 6 is an example schematic diagram of a data file into which graph state data is written according to an embodiment of this specification. As shown in FIG. 6, the data file includes some ordered data blocks obtained after the data compression (e.g., data block 1, data block 2, . . . , and data block n) and a metadata block. Each ordered data block stores a value corresponding to a key and is stored in order in the data file. Each ordered data block can store values corresponding to one or more keys. In addition, a value corresponding to one key can alternatively be stored in two or more adjacent ordered data blocks. The metadata block is stored at the end of the data file.

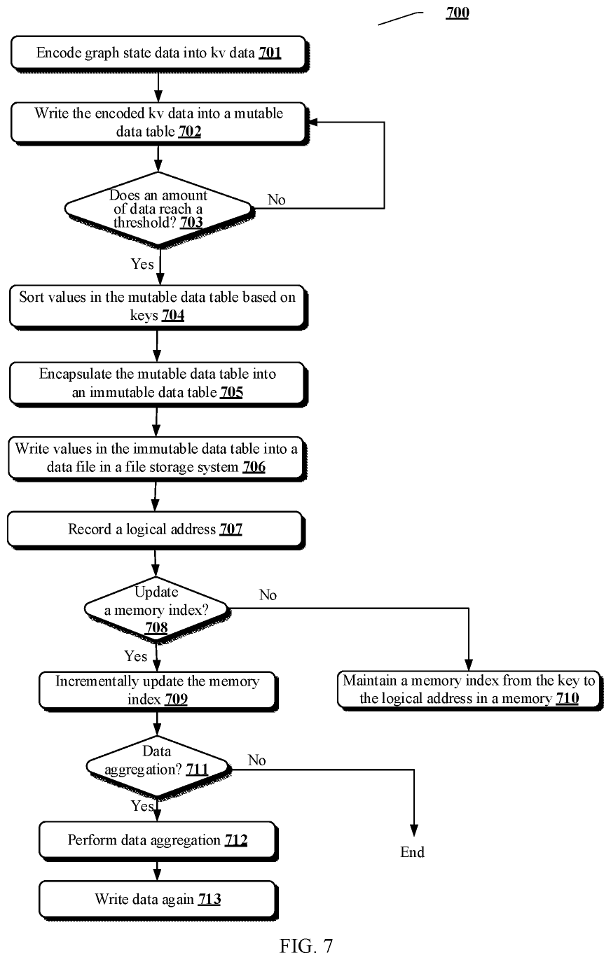

FIG. 7 is another example flowchart of a graph state data writing method 700 according to an embodiment of this specification. In the example of FIG. 7, the memory of the graph state management device maintains a mutable data table (mutable table) and an immutable data table (immutable table). The kv data can be continuously written into the mutable table. The data stored in the immutable table and the data sorting (data storage order) are locked and do not change. That is, the kv data is not allowed to be written into the immutable table.

As shown in FIG. 7, at 701, after the graph state data is acquired in batches from the graph computing engine, the graph state data management apparatus can use the above-mentioned data encoding method to encode each piece of graph state data in the acquired graph state data into kv data.

At 702, the graph state data management apparatus writes the encoded kv data into the mutable table. Specifically, it is determined whether there is an idle mutable table in the memory of the graph state management device. If there is an idle mutable table in the memory of the graph state management device, the graph state data management apparatus writes the encoded kv data into the idle mutable table. If there is no idle mutable table in the memory of the graph state management device, the graph state data management apparatus creates a new mutable table in the memory, and then writes the encoded kv data into the new mutable table. Here, the mutable table is equivalent to a segment of memory space in the memory. In an example, the mutable table can be created one by one. In another example, a plurality of mutable tables can be created at one single time, and the encoded kv data can be concurrently written into the plurality of mutable tables.

At 703, the graph state data management apparatus determines whether a mutable table into which the kv data is written reaches a threshold, for example, 64M. If the threshold is not reached, the graph state data management apparatus returns to step 702 to continue writing the kv data. If the threshold is reached, at 704, the graph state data management apparatus sorts the kv data in the mutable table based on the key, to form the kv list data, thereby ensuring that data aggregation is implemented for vertex data with the same vertex ID or edge data with the same edge start ID in the mutable table.

At 705, the graph state data management apparatus encapsulates the sorted mutable table into an immutable table. The immutable table may have a specified data size such as 64M.

At 706, the graph state data management apparatus writes the values in the immutable table into a data file in the file storage system in sequence (based on a sorting result of the corresponding keys). For example, the graph state data management apparatus writes the values in the immutable table into the data file in the file storage system in sequence by using an asynchronous thread. At 707, the graph state data management apparatus records a corresponding logical address of each key in the data file.

Optionally, at 707, the graph state data management apparatus can further determine whether the memory index needs to be updated. For example, the graph state data management apparatus can determine whether the memory index needs to be updated, by checking whether the currently written graph state data is the first batch of graph state data, or by checking whether the currently written graph state data is the data that is written for the first time after data compact is performed on the data file in the file storage system. If the currently written graph state data is the first batch of graph state data, or the currently written graph state data is the data that is written for the first time after data compact is performed on the data file in the file storage system, the graph state data management apparatus determines that the memory index does not need to be updated. If the currently written graph state data is not the first batch of graph state data, and the currently written graph state data is not the data that is written for the first time after data compact is performed on the data file in the file storage system, the graph state data management apparatus determines that the memory index needs to be updated.

If it is determined that the memory index needs to be updated, at 709, the graph state data management apparatus performs incremental index update on the memory index maintained in the memory of the graph state management device. If it is determined that the memory index does not need to be updated, at 710, the graph state data management apparatus maintains, in the memory of the graph state management device, the memory index from the key to the logical address.

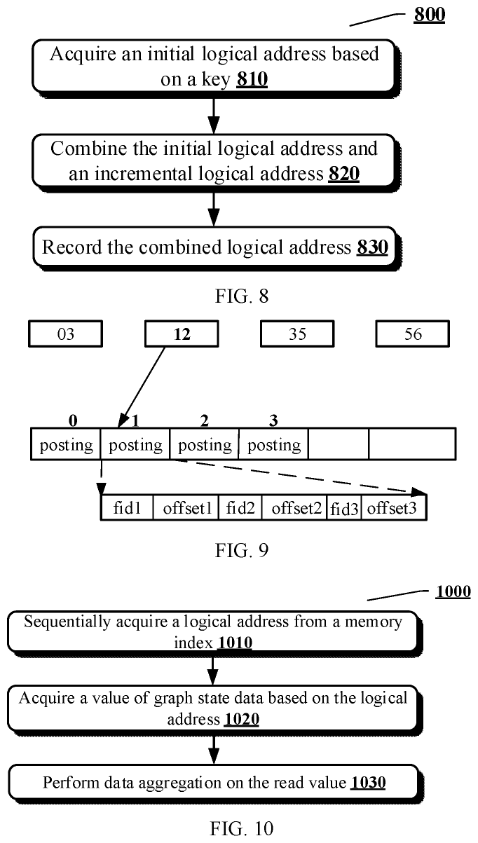

FIG. 8 is an example flowchart of a memory index update process 800 according to an embodiment of this specification.

As shown in FIG. 8, at 810, the graph state data management apparatus acquires, based on the key corresponding to the value written into the data file, an initial logical address in a memory index file, that is, a logical address stored during last writing of graph state data.

At 820, the graph state data management apparatus combines the initial logical address and an incremental logical address stored during current writing of graph state data. Here, the combining process means adding the incremental logical address to the end of the initial logical address. At 830, the graph state data management apparatus records the combined logical address in the memory index.

FIG. 9 is an example schematic diagram of an updated memory index structure according to an embodiment of this specification. In the example of FIG. 9, fd1+offset1 and fd2+offset2 are initial logical addresses, and fd3+offset3 is a logical address corresponding to 12 during current writing of graph state data.

Referring back to FIG. 7, optionally, after incremental update of the memory index is completed, at 711, the graph state data management apparatus can further determine whether a data compact condition needs to be satisfied. Here, data compact may mean aggregating values corresponding to the same key distributed in a plurality of different data files into the same data file, or deleting expired graph state data from the graph state data stored in the data file. The data compact condition may include but is not limited to the following: a quantity of fids included in the logical address corresponding to the same key exceeds a predetermined value; a data size of the value corresponding to the same key exceeds a predetermined threshold, and so on.

When it is determined that the data compact condition is satisfied, at 712, the graph state management apparatus performs a data compact process, and at 713, the graph state management apparatus writes the graph state data obtained after completion of the data compact into the data file in the file storage system again. For a process of writing the graph state data again, references can be made to the process of writing the graph state data described above with reference to FIG. 2.

FIG. 10 is an example flowchart of a graph state data compact process 1000 according to an embodiment of this specification.

As shown in FIG. 10, at 1010, the graph state data management apparatus sequentially acquires the logical address corresponding to each key from the memory index, and at 1020, the graph state data management apparatus acquires the value corresponding to each key based on the acquired logical address corresponding to each key.

After obtaining the value corresponding to each key, at 1030, the graph state data management apparatus performs data compact on the obtained value. For example, the graph state data management apparatus sorts the obtained values again based on the key, or deletes an expired value based on a time to live (TTL) of each value.

Based on the above-mentioned data compact processing, the values corresponding to the same key can be written into the same data file as much as possible, thereby shortening a data reading time during reading of the graph state data. Alternatively, deleting the expired value can reduce an amount of data written into the data file, thereby reducing the occupied storage space of the file storage system.

It should be noted that various modifications can be further made to the embodiment shown in FIG. 7. In some embodiments, the data file writing process described in FIG. 5 can be added to the embodiment of FIG. 7. In some embodiments, some or all of the steps in 708-709 and 711-713 can be deleted from the embodiment of FIG. 7.

The process of writing graph state data according to an embodiment of this specification has been described above. After the graph state data is written into the data file in the file storage system, when the graph computing engine performs graph computing again, the graph state data of the previous iterative computation process needs to be read from the file storage system.

FIG. 11 is an example flowchart of a graph state data reading method 1100 according to an embodiment of this specification.

As shown in FIG. 11, at 1110, in response to receiving a graph state data reading request from the graph computing engine, the graph state data management apparatus encodes a data ID in the graph state data reading request into a target key. When the graph state data requested to be read is vertex data, the data ID is a vertex ID. When the graph state data requested to be read is edge data, the data ID is an edge start ID. When the graph state data requested to be read includes the vertex data and the edge data, the data ID includes the vertex ID and the edge start ID.

At 1120, the graph state data management apparatus queries, based on the obtained target key, a corresponding logical address in the memory index maintained in the memory of the graph state management device.

After the corresponding logical address is identified, at 1130, the graph state data management apparatus acquires a value corresponding to the target key based on the identified logical address.

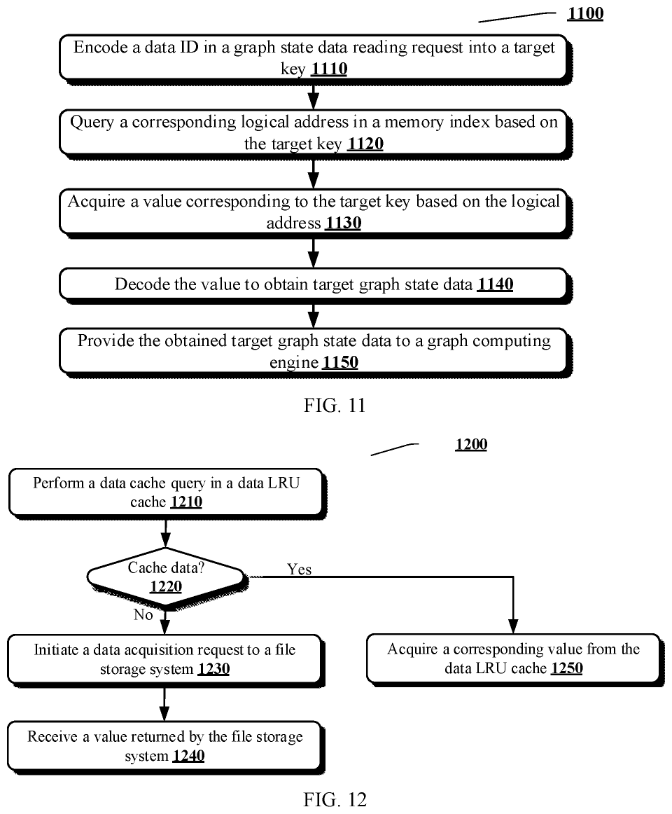

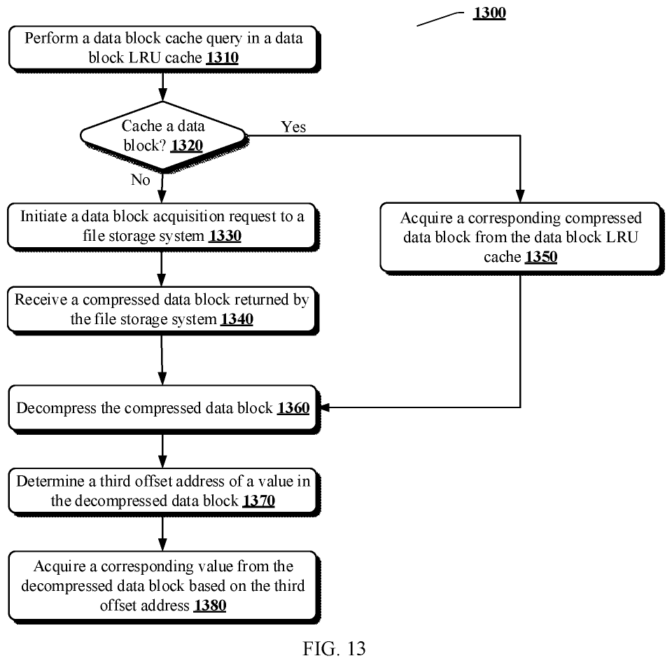

FIG. 12 is an example flowchart of a value acquisition process 1200 according to an embodiment of this specification. In the example of FIG. 12, the memory of the graph state management device maintains a data LRU cache, and the data LRU cache is used to cache the previously acquired value in association with the corresponding logical address of the key.

As shown in FIG. 12, when acquiring the value corresponding to the target key based on the identified logical address, at 1210, the graph state data management apparatus performs a data cache query in the data LRU cache by using the logical address, and at 1220, the graph state data management apparatus determines whether the value corresponding to the target key is cached in the data LRU cache.

If it is determined that the value corresponding to the target key is cached in the data LRU cache, at 1250, the graph state data management apparatus acquires the corresponding value from the data LRU cache.

If it is determined that no value corresponding to the target key is cached in the data LRU cache, at 1230, the graph state data management apparatus initiates a data acquisition request to the file storage system, where the initiated data acquisition request includes the corresponding logical address. After receiving the data acquisition request, the file storage system acquires the corresponding value from the data file in the file storage system based on the logical address in the data acquisition request. For example, the file storage system can identify the corresponding data file by using the file ID in the logical address, and acquire the corresponding value from the data file based on the first file offset address.

At 1240, the graph state data management apparatus receives the identified value from the file storage system.

It should be noted that, in another embodiment, the memory of the graph state management device may not maintain the data LRU cache. In this case, the data cache judging step and the step of acquiring the value from the data LRU cache need to be removed from FIG. 12.

FIG. 13 is another example flowchart of a value acquisition process 1300 according to an embodiment of this specification. In the example of FIG. 13, a value of the graph state data is constructed into a plurality of ordered data blocks with a first data size, the ordered data blocks are written into a data file in the file storage system after data compression, the data file includes each ordered data block obtained after the data compression and a metadata block, and metadata in the metadata block records a mapping relationship between the first file offset address corresponding to the key and a second file offset address of the compressed ordered data block in the data file. In addition, the memory of the graph state management device maintains a data block LRU cache, and the data block LRU cache is used to cache the previously acquired data block in association with the corresponding logical address of the key.

As shown in FIG. 13, when acquiring the value corresponding to the target key based on the identified logical address, at 1310, the graph state data management apparatus performs a data block cache query in the data block LRU cache by using the logical address, and at 1320, the graph state data management apparatus determines whether the compressed data block corresponding to the target key is cached in the data block LRU cache.

If it is determined that the compressed data block corresponding to the target key is cached in the data block LRU cache, at 1350, the graph state data management apparatus acquires the corresponding compressed data block from the data block LRU cache, and performs step 1360.

If it is determined that no compressed data block corresponding to the target key is cached in the data block LRU cache, at 1330, the graph state data management apparatus initiates a data block acquisition request to the file storage system, where the data block acquisition request includes the corresponding logical address. After receiving the data block acquisition request, the file storage system acquires the corresponding compressed data block from the data file in the file storage system based on the logical address in the data block acquisition request. Specifically, the file storage system can identify the corresponding data file by using the file ID in the logical address. Next, the file storage system acquires the corresponding metadata from the metadata block of the data file, and determines the second file offset address of the compressed data block in the data file by using a mapping relationship between the first file offset address in the corresponding metadata and the second file offset address of the compressed data block in the data file. Then, the file storage system acquires the corresponding compressed data block from the data file based on the second file offset address.

At 1340, the graph state data management apparatus receives, from the file storage system, the compressed data block returned in response to the data block acquisition request, and then performs step 1360. At 1360, the graph state data management apparatus decompresses the obtained compressed data block.

At 1370, the graph state data management apparatus determines a third offset address of the value corresponding to the target key in the decompressed ordered data block based on the first file offset address in the logical address and the first data size (that is, the data size of the uncompressed ordered data block). For example, a modulo operation with the first data size as a modulus can be performed on the first file offset address, and an obtained remainder result is the third offset address of the value corresponding to the target key in the decompressed ordered data block.

At 1380, the graph state data management apparatus acquires the value corresponding to the target key from the decompressed ordered data block based on the third offset address.

Referring back to FIG. 11, as described above, after acquiring the value corresponding to the target key, at 1140, the graph state data management apparatus decodes the acquired value to obtain the target graph state data. For example, the graph state data management apparatus can decode the acquired value to obtain data of a non-data ID part in the target graph state data. In an example, the data, obtained through decoding, of the non-data ID part can be used as the target graph state data. In another example, the data, obtained through decoding, of the non-data ID part can be combined with the data ID to obtain the target graph state data. Then, at 1150, the graph state data management apparatus provides the obtained target graph state data to the graph computing engine, so that the graph computing engine performs graph computing.

Optionally, in an embodiment, before the providing the obtained graph state data to the graph computing engine, the graph state data management method may further include: performing data filtering on the obtained graph state data by using a given data filtering policy. For example, a TTL-based expired data deletion mechanism is used to delete the expired graph state data from the obtained graph state data. In addition, data filtering can alternatively be performed on the obtained graph state data based on another data filtering condition.

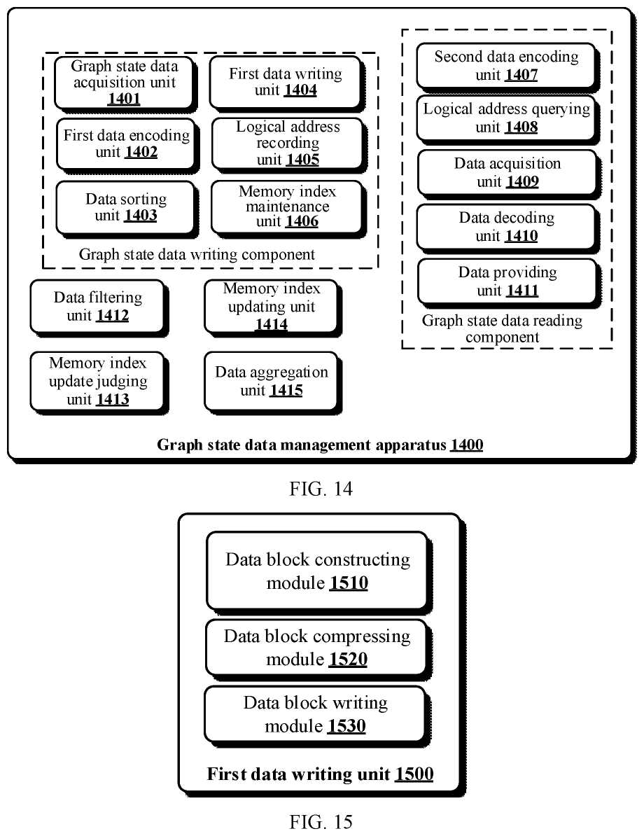

FIG. 14 is an example block diagram of a graph state data management apparatus 1400 according to an embodiment of this specification.

As shown in FIG. 14, the graph state data management apparatus 1400 may include a graph state data writing component. The graph state data writing component is configured to batch write the graph state data acquired in batches from the graph computing engine into the file storage system. In an example, the graph state data writing component may include a graph state data acquisition unit 1401, a first data encoding unit 1402, a data sorting unit 1403, a first data writing unit 1404, a logical address recording unit 1405, and a memory index maintaining unit 1406.

The graph state data acquisition unit 1401 is configured to batch acquire graph state data that is obtained by a graph computing engine during graph computation, where the graph state data includes vertex data and/or edge data. For an operation of the graph state data acquisition unit 1401, references can be made to the operation described above with reference to step 210 in FIG. 2.

The first data encoding unit 1402 is configured to encode each piece of graph state data in the acquired graph state data into kv data. When the graph state data is vertex data, the vertex ID in the vertex data is encoded into a key in the kv data, and the non-vertex ID data in the vertex data is encoded into a value in the kv data. The non-vertex ID data may include, for example, vertex metadata and a vertex attribute. When the graph state data is edge data, the start ID in the edge data is encoded into a key in the kv data, and the non-start ID data in the edge data is encoded into a value in the kv data. The non-start ID data may include, for example, an end ID, edge metadata, and an edge attribute. For an operation of the first data encoding unit 1402, references can be made to the operation described above with reference to step 220 in FIG. 2.

The data sorting unit 1403 is configured to sort, based on the key of the kv data, the kv data obtained through encoding, to form the kv list data. In the kv list data, each key corresponds to one or more values. For an operation of the data sorting unit 1403, references can be made to the operation described above with reference to step 230 in FIG. 2.

The first data writing unit 1404 is configured to sequentially write values of the kv list data into a data file in a file storage system. For an operation of the first data writing unit 1404, references can be made to the operation described above with reference to step 240 in FIG. 2.

The logical address recording unit 1405 is configured to record a corresponding logical address of each key in the data file, where the logical address includes a file ID of a data file into which the value corresponding to the key is written, and a first file offset address of the corresponding value in the written data file. For an operation of the logical address recording unit 1405, references can be made to the operation described above with reference to step 250 in FIG. 2.

The memory index maintenance unit 1406 is configured to maintain a memory index of the acquired graph state data in a memory of the graph state management device, where the memory index is used to reflect an index relationship between a key and a corresponding logical address. For an operation of the memory index maintenance unit 1406, references can be made to the operation described above with reference to step 260 in FIG. 2.

In some embodiments, to further reduce the amount of data written into the file storage system, data compression can be performed on the value of the sorted kv list data, and the compressed value can be written into the file storage system.

FIG. 15 is an example block diagram of a first data writing unit 1500 according to an embodiment of this specification. The first data writing unit 1500 can perform data compression on the value in the kv data, and then write the compressed value into the data file in the file storage system. As shown in FIG. 15, the first data writing unit 1500 includes a data block constructing module 1510, a data block compressing module 1520, and a data block writing module 1530.

The data block constructing module 1510 is configured to construct the values of the kv list data into a plurality of ordered data blocks with a first data size. For an operation of the data block constructing module 1510, references can be made to the operation described above with reference to step 510 in FIG. 5.

The data block compressing module 1520 is configured to perform data compression on the constructed ordered data blocks. For an operation of the data block compressing module 1520, references can be made to the operation described above with reference to step 520 in FIG. 5.

The data block writing module 1530 is configured to sequentially write the ordered data blocks obtained after the data compression into a data file in the file storage system, where the data file includes each ordered data block obtained after the data compression and a metadata block, and metadata in the metadata block records a mapping relationship between the first file offset address corresponding to the key and a second file offset address of the compressed ordered data block in the data file. For an operation of the data block writing module 1530, references can be made to the operation described above with reference to step 530 in FIG. 5.

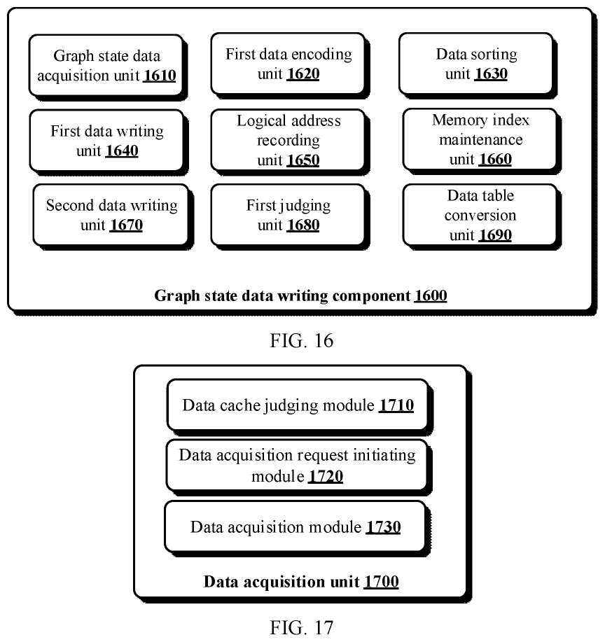

FIG. 16 is another example block diagram of a graph state data writing component 1600 according to an embodiment of this specification. In the example of FIG. 16, the memory of the graph state management device maintains a mutable data table and an immutable data table. As shown in FIG. 16, the graph state data writing component includes a graph state data acquisition unit 1610, a first data encoding unit 1620, a data sorting unit 1630, a first data writing unit 1640, a logical address recording unit 1650, a memory index maintenance unit 1660, a second data writing unit 1670, a first judging unit 1680, and a data table conversion unit 1690.

The graph state data acquisition unit 1610 is configured to batch acquire graph state data that is obtained by a graph computing engine during graph computation, where the graph state data includes vertex data and/or edge data. The first data encoding unit 1620 is configured to encode each piece of graph state data in the acquired graph state data into kv data. When the graph state data is vertex data, the vertex ID in the vertex data is encoded into a key in the kv data, and the non-vertex ID data in the vertex data is encoded into a value in the kv data. The non-vertex ID data may include, for example, vertex metadata and a vertex attribute. When the graph state data is edge data, the start ID in the edge data is encoded into a key in the kv data, and the non-start ID data in the edge data is encoded into a value in the kv data. The non-start ID data may include, for example, an end ID, edge metadata, and an edge attribute.

The second data writing unit 1670 writes the encoded kv data into the mutable data table. After the encoded kv data is written into the mutable data table, the first judging unit 1680 is configured to determine whether a data size of the mutable data table into which the kv data is written reaches a threshold.

In response to that the data size of the mutable data table into which the kv data is written reaches the threshold, the data sorting unit 1630 is configured to sort, based on the key of the kv data, the kv data written into the mutable data table, to form the kv list data. After the sorting of the kv data in the mutable data table is completed, the data table conversion unit 1690 is configured to convert the sorted mutable data table into an immutable data table.

The first data writing unit 1640 is configured to sequentially write values of the immutable data table into a data file in the file storage system, where each immutable data table corresponds to one data file. The logical address recording unit 1650 is configured to record a corresponding logical address of each key in the data file, where the logical address includes a file ID of a data file into which the value corresponding to the key is written, and a first file offset address of the corresponding value in the written data file.

After the immutable data table is written into the data file in the file storage system and the corresponding logical address of each key is recorded, the memory index maintenance unit 1660 is configured to maintain a memory index of the acquired graph state data in a memory of the graph state management device, where the memory index is used to reflect an index relationship between a key and a corresponding logical address.

It should be noted that the first data writing unit 1640 in FIG. 16 can also be implemented by using the first data writing unit 1500 shown in FIG. 15. In this case, the data block constructing module is configured to construct the values in the immutable data table into a plurality of ordered data blocks with a first data size. In addition, in some embodiments, the first data writing unit 1640 and the second data writing unit 1670 can be implemented by using the same unit.

The graph state data management apparatus 1400 may include a graph state data reading component. The graph state data reading component is configured to: in response to receiving a graph state data reading request from the graph computing engine, read corresponding graph state data and return the graph state data to the graph computing engine. As shown in FIG. 14, the graph state data reading component may include a second data encoding unit 1407, a logical address querying unit 1408, a data acquisition unit 1409, a data decoding unit 1410, and a data providing unit 1411.

The second data encoding unit 1407 is configured to: in response to receiving a graph state data reading request from the graph computing engine, encode a data ID in the graph state data reading request into a target key. For an operation of the second data encoding unit 1407, references can be made to the operation described above with reference to step 1110 in FIG. 11.

The logical address querying unit 1408 is configured to query, based on the target key, a corresponding logical address in the memory index maintained in the memory of the graph state management device. For an operation of the logical address querying unit 1408, references can be made to the operation described above with reference to step 1120 in FIG. 11.

The data acquisition unit 1409 is configured to acquire a value corresponding to the target key based on the logical address. For an operation of the data acquisition unit, references can be made to the operation described above with reference to step 1130 in FIG. 11.

The data decoding unit 1410 is configured to decode the acquired value to obtain target graph state data. For example, the data decoding unit 1410 can decode the acquired value to obtain data of a non-data ID part in the target graph state data. In an example, the data decoding unit 1410 can use the data, obtained through decoding, of the non-data ID part as the target graph state data. In another example, the data decoding unit 1410 can combine the data, obtained through decoding, of the non-data ID part with the data ID to obtain the target graph state data. For an operation of the data decoding unit 1410, references can be made to the operation described above with reference to step 1140 in FIG. 1.

The data providing unit 1411 is configured to provide the obtained target graph state data to the graph computing engine. For an operation of the data providing unit 1411, references can be made to the operation described above with reference to step 1150 in FIG. 11.

Optionally, in some embodiments, the graph state data management apparatus 1400 may further include a data filtering unit 1412. The data filtering unit 1412 is configured to: before the providing the obtained target graph state data to the graph computing engine, perform data filtering on the obtained target graph state data by using a given data filtering policy.

Optionally, in some embodiments, the graph state data management apparatus 1400 may further include a memory index update judging unit 1413 and a memory index updating unit 1414. The memory index update judging unit 1413 is configured to: after the sequentially writing values of the kv list data into a data file in a file storage system, and recording a corresponding logical address of each key in the data file, determine whether the memory index needs to be updated. The memory index updating unit 1414 is configured to: in response to determining that the memory index needs to be updated, perform incremental logical address update on a corresponding logical address in the memory index by using the recorded logical address of each key.

In some embodiments, the memory index update judging unit 1413 and the memory index updating unit 1414 can form a graph state data updating component together with the graph state data writing component. The graph state data updating component can perform data update on the graph state data stored in the data file in the file storage system. The update operation of the graph state data updating component can be implemented by using a batch update policy. The incremental graph state data is written into the data file in the file storage system in an append-only manner, and for each key, the initial logical address and a subsequent incremental logical address are maintained in the memory index.

In some embodiments, the graph state data management apparatus 1400 may further include a data aggregation unit 1415. In response to satisfying the data compact condition, the data aggregation unit 1415 uses the given data compact policy to perform data compact on the value stored in the data file in the file storage system.

FIG. 17 is an example block diagram of a data acquisition unit 1700 according to an embodiment of this specification. In the example of FIG. 17, the memory of the graph state management device maintains a data LRU cache, and the data LRU cache is used to cache the previously acquired value in association with the corresponding logical address of the key. As shown in FIG. 17, the data acquisition unit 1700 includes a data cache judging module 1710, a data acquisition request initiating module 1720, and a data acquisition module 1730.

The data cache judging module 1710 is configured to: after a corresponding logical address is identified, determine, based on the logical address, whether the value corresponding to the target key is cached in the data LRU cache.

If the value corresponding to the target key is cached in the data LRU cache, the data acquisition module 1730 acquires the corresponding value from the data LRU cache.

If no value corresponding to the target key is cached in the data LRU cache, the data acquisition request initiating module 1720 initiates a data acquisition request to the file storage system, where the data acquisition request includes the corresponding logical address. The data acquisition module 1730 is configured to receive, from the file storage system, a value returned in response to the data acquisition request, where the returned value is acquired by the file storage system from a data file in the file storage system based on the corresponding logical address.

In some embodiments, the memory of the graph state management device may not maintain the data LRU cache. In this case, the data cache judging module 1710 needs to be removed from the data acquisition unit shown in FIG. 17.

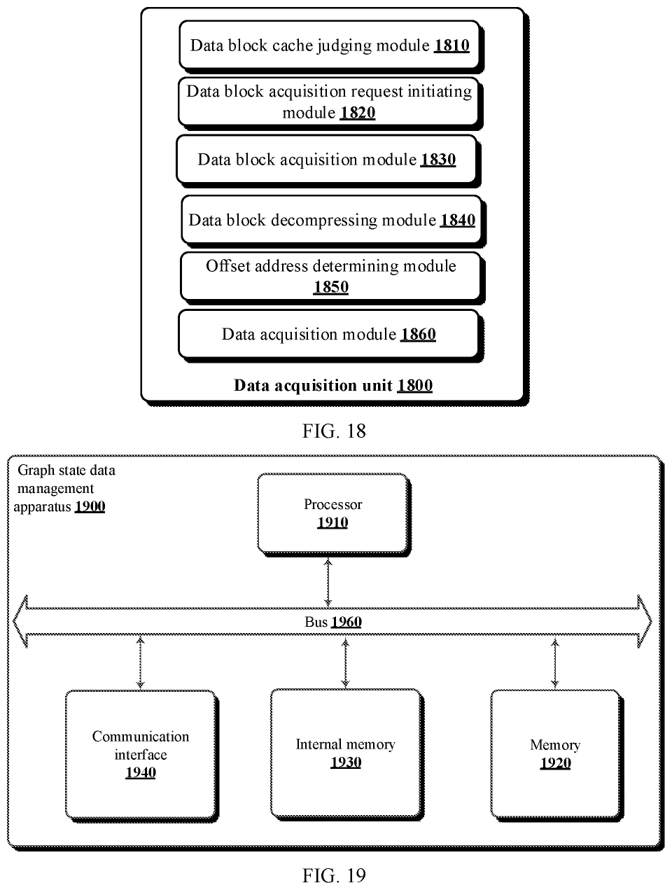

FIG. 18 is another example block diagram of a data acquisition unit 1800 according to an embodiment of this specification. In the example of FIG. 18, a value of the graph state data is constructed into a plurality of ordered data blocks with a first data size, the ordered data blocks are written into a data file in the file storage system after data compression, the data file includes each ordered data block obtained after the data compression and a metadata block, and metadata in the metadata block records a mapping relationship between the first file offset address corresponding to the key and a second file offset address of the compressed ordered data block in the data file. In addition, the memory of the graph state management device maintains a data block LRU cache, and the data block LRU cache is used to cache the previously acquired data block in association with the corresponding logical address of the key.

As shown in FIG. 18, the data acquisition unit 1800 includes a data block cache judging module 1810, a data block acquisition request initiating module 1820, a data block acquisition module 1830, a data block decompressing module 1840, an offset address determining module 1850, and a data acquisition module 1860.

The data block cache judging module 1810 is configured to: after a corresponding logical address is identified, determine, based on the logical address, whether the compressed data block corresponding to the target key is cached in the data block LRU cache.

When the compressed data block corresponding to the target key is cached in the data block LRU cache, the data block acquisition module 1830 is configured to acquire the corresponding compressed data block from the data block LRU cache.

When no compressed data block corresponding to the target key is cached in the data block LRU cache, the data block acquisition request initiating module 1820 is configured to initiate a data block acquisition request to the file storage system, where the data block acquisition request includes the corresponding logical address. In this case, the data block acquisition module 1830 is configured to receive, from the file storage system, a compressed data block returned in response to the data block acquisition request, where the returned compressed data block is acquired by the file storage system from a data file in the file storage system based on the first file offset address.

As described above, after obtaining the compressed data block, the data block decompressing module 1840 is configured to decompress the obtained compressed data block. The offset address determining module 1850 is configured to determine, based on the first file offset address in the logical address and a specified size of the data block (that is, the first data size), a third offset address of the value corresponding to the target key in the decompressed data block.

As described above, after obtaining the third offset address, the data acquisition module 1860 is configured to acquire the value corresponding to the target key from the decompressed data block based on the third offset address.

In some embodiments, the memory of the graph state management device may not maintain the data block LRU cache. In this case, the data block cache judging module 1810 needs to be removed from the data acquisition unit shown in FIG. 18.

Referring to FIG. 1 to FIG. 18, the graph state data management method and the graph state data management apparatus according to an embodiment of this specification have been described. The above-mentioned graph state data management apparatus can be implemented by using hardware, or can be implemented by using software or a combination of hardware and software.

FIG. 19 is a schematic diagram of a graph state data management apparatus 1900 implemented based on a computer system according to an embodiment of this specification. As shown in FIG. 19, the graph state data management apparatus 1900 may include at least one processor 1910, a memory (for example, a non-volatile memory) 1920, an internal memory 1930, and a communication interface 1940, and the at least one processor 1910, the memory 1920, the internal memory 1930, and the communication interface 1940 are connected together through a bus 1960. The at least one processor 1910 executes at least one computer-readable instruction (namely, the above-mentioned elements implemented in a software form) stored or encoded in the memory.

In an embodiment, the memory stores a computer-executable instruction, and when the computer-executable instruction is executed, the at least one processor 1910 is enabled to perform the following operations: batch acquiring graph state data that is obtained by a graph computing engine during graph computation, where the graph state data includes vertex data and/or edge data; encoding each piece of graph state data in the acquired graph state data into kv data, where a vertex ID in the vertex data and/or a start ID in the edge data is encoded into a key, and non-vertex ID data in the vertex data and/or non-start ID data in the edge data is encoded into a value; sorting the kv data based on a key of the kv data to form kv list data, where in the kv list data, each key corresponds to one or more values; sequentially writing values of the kv list data into a data file in a file storage system, and recording a corresponding logical address of each key in the data file, where the recorded logical address includes a file ID of a data file into which the value corresponding to the key is written, and a first file offset address of the corresponding value in the written data file; and maintaining a memory index of the acquired graph state data in a memory of the graph state management device, where the memory index is used to reflect an index relationship between a key and a corresponding logical address.

It should be understood that, when being executed, the computer-executable instruction stored in the memory enables the at least one processor 1910 to perform various operations and functions described above with reference to FIG. 1 to FIG. 18 in embodiments of this specification.

According to an embodiment, a program product such as a machine-readable medium (for example, a non-transitory machine-readable medium) is provided. The machine-readable medium may have an instruction (namely, the above-mentioned elements implemented in a software form). When the instruction is executed by a machine, the machine is enabled to perform the above-mentioned operations and functions described with reference to FIG. 1 to FIG. 18 in embodiments of this specification. Specifically, a system or an apparatus with a readable storage medium can be provided, the readable storage medium stores software program code for implementing the functions in any one of the embodiments described above, and a computer or a processor of the system or the apparatus is enabled to read and execute the instructions stored in the readable storage medium.

In this case, the program code read from the readable medium can implement the functions in any one of the embodiments described above, and therefore the machine-readable code and the readable storage medium storing the machine-readable code form a part of this specification. Embodiments of the readable storage medium include a floppy disk, a hard disk, a magneto-optical disk, an optical disc (such as a CD-ROM, a CD-R, a CD-RW, a DVD-ROM, a DVD-RAM, a DVD-RW, and a DVD-RW), a magnetic tape, a non-volatile memory card, and a ROM. Alternatively, the program code can be downloaded from a server computer or a cloud by a communication network.

According to an embodiment, a computer program product is provided, where the computer program product includes a computer program, and when the computer program is executed by a processor, the processor is enabled to perform the operations and functions described above with reference to FIG. 1 to FIG. 18 in embodiments of this specification.

A person skilled in the art should understand that various variations and modifications can be made to embodiments disclosed above without departing from the essence of this specification. Therefore, the protection scope of this specification should be defined by the appended claims.

It should be noted that, not all the steps and units in the above-mentioned processes and system structure diagrams are necessary, and some steps or units can be ignored based on an actual need. An order of performing the steps is not fixed, and can be determined based on a need. The apparatus structure described in the above-mentioned embodiments may be a physical structure or a logical structure. In other words, some units can be implemented by the same physical entity, or some units can be implemented by a plurality of physical entities, or can be implemented together by some components in a plurality of independent devices.

In the above-mentioned embodiments, a hardware unit or module can be implemented mechanically or electrically. For example, a hardware unit, a module, or a processor may include a permanent dedicated circuit or logic (such as a dedicated processor, FPGA, or ASIC) to complete a corresponding operation. The hardware unit or the processor may further include a programmable logic or circuit (such as a general-purpose processor or another programmable processor), and can be set temporarily by software to complete a corresponding operation. Specific implementations (mechanical methods, dedicated permanent circuits, or temporarily disposed circuits) can be determined based on cost and time considerations.

The specific implementations illustrated above with reference to the accompanying drawings describe example embodiments, but do not represent all embodiments that can be implemented or fall within the protection scope of the claims. The term “example” used throughout this specification means “used as an example, an instance, or an illustration”, but does not mean “preferred” or “advantageous” over other embodiments. Specific implementations include specific details for the purpose of providing an understanding of the described technologies. However, these technologies can be implemented without these specific details. In some instances, to avoid obscuring the described concepts in the embodiments, well-known structures and apparatuses are shown in the form of a block diagram.

The foregoing descriptions of the present disclosure are provided to enable any person of ordinary skill in the art to implement or use the present disclosure. Various modifications made to the present disclosure are apparent to a person of ordinary skill in the art, and the general principles defined in this specification can also be applied to other variants without departing from the protection scope of the present disclosure. Therefore, the present disclosure is not limited to the examples and designs described in this specification, but corresponds to the widest scope of principles and novel features disclosed in this specification.

1. A graph state data management method applied to a graph state management device, comprising:
batch acquiring graph state data that is obtained by a graph computing engine during graph computation, wherein the graph state data comprises vertex data and/or edge data;
encoding each piece of graph state data in the graph state data into key value (kv) data, wherein a vertex ID in the vertex data and/or a start ID in the edge data is encoded into a key, and non-vertex ID data in the vertex data and/or non-start ID data in the edge data is encoded into a value;
sorting the kv data based on a key of the kv data to form kv list data, wherein in the kv list data, each key corresponds to one or more values;
sequentially writing values of the kv list data into a data file in a file storage system, and recording a corresponding logical address of each key in the data file, wherein the logical address comprises a file ID of a data file into which the value corresponding to the key is written, and a first file offset address of the corresponding value in the written data file; and
maintaining a memory index of the graph state data in a memory of the graph state management device, wherein the memory index is used to reflect an index relationship between a key and a corresponding logical address.

2. The graph state data management method according to claim 1, wherein the memory of the graph state management device maintains a mutable data table and an immutable data table;
before sorting the kv data based on a key of the kv data, the graph state data management method further comprises:
writing the kv data into the mutable data table; and
determining whether a data size of the mutable data table into which the kv data is written reaches a threshold;
sorting the kv data based on a key of the kv data comprises:
in response to that the data size of the mutable data table into which the kv data is written reaches the threshold, sorting, based on the key of the kv data, the kv data written into the mutable data table; and
sequentially writing values of the kv list data into a data file in a file storage system comprises:
converting the sorted mutable data table into an immutable data table; and
sequentially writing values of the immutable data table into a data file in the file storage system, wherein each immutable data table corresponds to one data file.

3. The graph state data management method according to claim 1, wherein sequentially writing values of the kv list data into a data file in a file storage system comprises:
constructing the values of the kv list data into a plurality of ordered data blocks with a first data size;
performing data compression on the constructed ordered data blocks; and
sequentially writing the ordered data blocks obtained after the data compression into a data file in the file storage system, wherein the data file comprises each ordered data block obtained after the data compression and a metadata block, and metadata in the metadata block records a mapping relationship between the first file offset address corresponding to the key and a second file offset address of the compressed ordered data block in the data file.

4. The graph state data management method according to claim 1, further comprising:
in response to receiving a graph state data reading request from the graph computing engine, encoding a data ID in the graph state data reading request into a target key, wherein the data ID comprises a vertex ID and/or an edge start ID;
querying a corresponding logical address in the memory index based on the target key;
acquiring a value corresponding to the target key based on the logical address;
decoding the acquired value to obtain target graph state data; and
providing the obtained target graph state data to the graph computing engine.

5. The graph state data management method according to claim 4, wherein acquiring a value corresponding to the target key based on the logical address comprises:
in response to identifying the corresponding logical address, initiating a data acquisition request to the file storage system, wherein the data acquisition request comprises the corresponding logical address; and
receiving, from the file storage system, a value returned in response to the data acquisition request, wherein the returned value is acquired by the file storage system from a data file in the file storage system based on the corresponding logical address.

6. The graph state data management method according to claim 5, wherein the memory of the graph state management device maintains a data LRU cache, and the data LRU cache is used to cache the previously acquired value in association with the corresponding logical address of the key; and
before initiating a data acquisition request to the file storage system, acquiring a value corresponding to the target key based on the logical address further comprises:
determining, based on the logical address, whether the value corresponding to the target key is cached in the data LRU cache; and
upon determining that the value corresponding to the target key is cached in the data LRU cache, acquiring the corresponding value from the data LRU cache.

7. The graph state data management method according to claim 4, wherein a value of the graph state data is constructed into a plurality of ordered data blocks with a first data size, the ordered data blocks are written into a data file in the file storage system after data compression, the data file comprises each ordered data block obtained after the data compression and a metadata block, and metadata in the metadata block records a mapping relationship between the first file offset address corresponding to the key and a second file offset address of the compressed ordered data block in the data file;
acquiring a value corresponding to the target key based on the logical address comprises:
in response to identifying the corresponding logical address, initiating a data block acquisition request to the file storage system, wherein the data block acquisition request comprises the corresponding logical address;
receiving, from the file storage system, a compressed data block returned in response to the data block acquisition request, wherein the compressed data block is acquired by the file storage system from a data file in the file storage system based on the first file offset address;
decompressing the obtained compressed data block;
determining, based on the first file offset address in the logical address and the first data size, a third offset address of the value corresponding to the target key in the decompressed data block; and
acquiring the value corresponding to the target key from the decompressed data block based on the third offset address.

8. The graph state data management method according to claim 7, wherein the memory of the graph state management device maintains a data block LRU cache, and the data block LRU cache is used to cache the previously acquired data block in association with the corresponding logical address of the key; and
before initiating a data block acquisition request to the file storage system, acquiring a value corresponding to the target key based on the logical address further comprises:
determining, based on the logical address, whether the compressed data block corresponding to the target key is cached in the data block LRU cache; and
upon determining that the compressed data block corresponding to the target key is cached in the data block LRU cache, acquiring the corresponding compressed data block from the data block LRU cache.

9. The graph state data management method according to claim 4, wherein before providing the obtained graph state data to the graph computing engine, the graph state data management method further comprises:
performing data filtering on the obtained graph state data by using a given data filtering policy.

10. The graph state data management method according to claim 1, wherein after sequentially writing values of the kv list data into a data file in a file storage system, and recording a corresponding logical address of each key in the data file, the graph state data management method further comprises:
determining whether the memory index needs to be updated; and
in response to determining that the memory index needs to be updated, performing incremental logical address update on a corresponding logical address in the memory index by using the recorded logical address of each key.

11. The graph state data management method according to claim 1, further comprising:
in response to satisfying a data aggregation condition, performing data aggregation on the values stored in the data file in the file storage system by using a given data aggregation policy.

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. A graph state data management apparatus, comprising: a memory and a processor, wherein the memory stores executable instructions that, in response to execution by the processor, cause the processor to:
batch acquire graph state data that is obtained by a graph computing engine during graph computation, wherein the graph state data comprises vertex data and/or edge data;
encode each piece of graph state data in the graph state data into kv data, wherein a vertex ID in the vertex data and/or a start ID in the edge data is encoded into a key, and non-vertex ID data in the vertex data and/or non-start ID data in the edge data is encoded into a value;
sort the kv data based on a key of the kv data to form kv list data, wherein in the kv list data, each key corresponds to one or more values;
sequentially write values of the kv list data into a data file in a file storage system, and record a corresponding logical address of each key in the data file, wherein the logical address comprises a file ID of a data file into which the value corresponding to the key is written, and a first file offset address of the corresponding value in the written data file; and
maintain a memory index of the graph state data in a memory of the graph state management device, wherein the memory index is used to reflect an index relationship between a key and a corresponding logical address.

24. A non-transitory computer-readable storage medium, comprising instructions stored therein that, when executed by a processor of a computing device, cause the processor to:
batch acquire graph state data that is obtained by a graph computing engine during graph computation, wherein the graph state data comprises vertex data and/or edge data;
encode each piece of graph state data in the graph state data into kv data, wherein a vertex ID in the vertex data and/or a start ID in the edge data is encoded into a key, and non-vertex ID data in the vertex data and/or non-start ID data in the edge data is encoded into a value;
sort the kv data based on a key of the kv data to form kv list data, wherein in the kv list data, each key corresponds to one or more values;
sequentially write values of the kv list data into a data file in a file storage system, and record a corresponding logical address of each key in the data file, wherein the logical address comprises a file ID of a data file into which the value corresponding to the key is written, and a first file offset address of the corresponding value in the written data file; and
maintain a memory index of the graph state data in a memory of the graph state management device, wherein the memory index is used to reflect an index relationship between a key and a corresponding logical address.

25. (canceled)
